(19) United States
(12) Patent Application Publication
(10) Pub. No.: US 2008/0248356 A1
(43) Pub. Date: Oct. 9, 2008

(54) Production Method for Sold Polymer Electrolyte Membrane, Solid Polymer Electrolyte Membrane, and Fuel Cell Including Solid Polymer Electrolyte Membrane

(75) Inventors: Hiroko Kimura, Shizuoka-ken (JP); Shinobu Sekine, Shizuoka-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi, Aichi-ken (JP)

(21) Appl. No.: 11/628,495

(22) PCT Filed: Jul. 14, 2005
(86) PCT No.: PCT/IB05/02012

§ 371 Date: Dec. 5, 2006

(30) Foreign Application Priority Data
Jul. 16, 2004 (JP) 2004-209708

(51) Int. Cl. H01M 8/10; C08J 5/22

(52) U.S. Cl. 429/30; 264/435

(57) ABSTRACT

The performance of an electrolyte membrane (21) is improved by imparting aeolotropy to physical properties of the electrolyte membrane (21). A first state solid polymer electrolyte membrane (21) containing a polymer having an ion-exchange group is softened, melted of dissolved, whereby a second state solid polymer electrolyte membrane (21) is formed. Then, the second state solid polymer electrolyte membrane (21) is cooled, while a strong magnetic field is applied to the second state solid polymer electrolyte membrane (21) in a predetermined direction, whereby the second state solid polymer electrolyte membrane (21) is hardened or solidified. As a result, the ion-conductivity in a membrane thickness direction can be improved in a fluorinated electrolyte membrane, and swelling in the membrane surface direction can be suppressed in an aromatic hydrocarbon electrolyte membrane.

### BACKGROUND OF THE INVENTION

1. Field of the Invention

The invention relates to a solid polymer electrolyte membrane having ion-conductivity, a production method for the solid polymer electrolyte membrane, and a fuel cell including the solid polymer electrolyte membrane.

2. Description of the Related Art

Recently, attention has been focused on a fuel cell which generates electric power by using an electrochemical reaction between hydrogen and oxygen, as a supply source of clean electric energy. Especially, great expectations have been placed on a polymer electrolyte fuel cell (PEFC) which uses a solid polymer as an electrolyte, since the PEFC can generate a large amount of electric power and operate at a low temperature.

As an electrolyte membrane used for a fuel cell, generally, a fluorinated electrolyte membrane typified by a perfluoro sulfonic acid membrane is used. The fluorinated electrolyte membrane has C—F bond, and has considerably high chemical stability. Accordingly, the fluorinated electrolyte membrane is suitable for use under severe conditions. Known examples of such an electrolyte membrane include a Nafion membrane (registered trademark of DuPont), a Dow membrane (Dow Chemical), an Aciplex membrane (registered trademark of Asahi Kasei Corporation), and a Flemion membrane (registered trademark of Asahi Glass Co., Ltd).

However, a fluorinated electrolyte membrane is difficult to produce, and considerably costly. Accordingly, inexpensive hydrocarbon electrolyte membranes have been proposed recently. Such a hydrocarbon electrolyte membrane is obtained by sulfonating an engineering plastic solid polymer. Examples of such an engineering plastic solid polymer include polyether ether ketone, polyether sulfone, polyether imide, and polyphenylene ether.

Examples of a method for forming such an electrolyte membrane include a cast method disclosed in Japanese Patent Application Publication No. JP (A) 11-116679 and a molten material extrusion method disclosed in Japanese Patent Application Publication No. JP (A) 2003-197220. In the cast method, an electrolyte polymer solution is spread on a flat plate, and then the electrolyte polymer solution is heated such that a solvent is volatilized, whereby a membranous electrolyte is obtained.

In the conventional type of electrolyte membrane formed by the cast method or the molten material extrusion method, solid polymers in the electrolyte are oriented in random directions. Accordingly, when the electrolyte membrane absorbs moisturizing water and water generated during electric power generation performed by the fuel cell, the electrolyte membrane swells isotropically. The electrolyte membrane also has isotropic ion-conductivity. The ion-conductivity is isotropic not only in a membrane thickness direction but also in a membrane surface direction. However, it is not always desirable that the electrolyte membrane has physical properties of swelling isotropically and having isotropic ion conductivity. Nevertheless, a close study has not been made concerning this issue.

### SUMMARY OF THE INVENTION

It is an object of the invention to improve performance of an electrolyte membrane by imparting aeolotropy to physical properties of the electrolyte membrane.

According to an aspect of the invention, there is provided a first production method for a solid polymer electrolyte membrane, including the steps of softening, melting or dissolving a first state solid polymer electrolyte membrane containing a polymer having an ion-exchange group, thereby forming a second state solid polymer electrolyte membrane; and applying a strong magnetic field to the second state solid polymer electrolyte membrane in a predetermined direction, while hardening or solidifying the second state solid polymer electrolyte membrane. With this production method, it is possible to easily produce the solid polymer electrolyte membrane in which the polymers are oriented and fixed in a certain direction.

In the above-mentioned aspect, the solid polymer electrolyte membrane may be hardened or solidified by being cooled.

In the above-mentioned aspect, in the first state solid polymer electrolyte membrane, at least one of substitution of fluorine or salt for the ion-exchange group, an end cap process for the ion-exchange group, and addition of a plasticizer may be performed. Accordingly, the melting viscosity is decreased and, therefore, it becomes easier for the polymer to move. As a result, the orientation of the polymer can be improved. Such an aspect is particularly effective, when a solid polymer electrolyte membrane which is difficult to soften or melt only by heating is used.

According to another aspect of the invention, there is provided a second production method, including the steps of dispersing a polymer having an ion-exchange group in a solvent, thereby preparing an electrolyte polymer; forming the electrolyte polymer into a membranous body; and applying a strong magnetic field to the membranous body in a predetermined direction, while volatilizing the solvent present in the membranous body. With this production method, it is possible to easily produce the solid polymer electrolyte membrane in which polymers are oriented and fixed in a certain direction. In addition, the flowability of the polymer is improved by the solvent. It is, therefore, possible to improve the orientation of the polymer.

In the above-mentioned aspect, the solvent present in the membranous body may be volatilized by being heated.

In the solid polymer electrolyte membrane produced by each of the first production method and the second production method, since the polymers are oriented and fixed in the certain direction due to application of the strong magnetic field, aeolotropy is imparted to a swelling characteristic and ion-conductivity. Namely, with each of the first production method and the second production method, it is possible to produce the solid polymer electrolyte membrane having physical properties with aeolotropy imparted, by controlling the direction in which the strong magnetic field is applied.

In each of the first production method and the second production method, in the polymer having the ion-exchange group, each molecule may have a molecular structure having magnetic field aeolotropy and a molecular structure having ion-conductivity. Thus, the molecular structure having magnetic field aeolotropy is oriented by the strong magnetic field, whereby the molecular structure having ion-conductivity can be also oriented. It is, therefore, possible to improve the ion-conductivity in a certain direction.

For example, the polymer may have a liner main chain, and side chains branched from the main chain, each of which has the ion-exchange group at the end thereof. In such a polymer, the main chain is oriented in the direction perpendicular to the direction in which the magnetic field is applied, and the side chains each of which has the ion-exchange group are oriented in the direction parallel to the direction in which the magnetic field is applied. It is, therefore, possible to produce the solid polymer electrolyte membrane with improved ion-conductivity in the direction in which the magnetic field is applied.

For example, if the polymer containing a sulfonic acid group as an ion-exchange group is used, the orientation can be further improved. If the polymer having benzene rings between the main chain and the ion-exchange groups is used, since the benzene ring has a relatively strong tendency to be oriented in the direction parallel to the direction in which the magnetic field is applied, it is possible to produce the electrolyte membrane with further improved ion-conductivity.

In each of the first production method and the second production method, the polymer having the ion-exchange group may be a compound of a polymer having magnetic field aeolotropy and a polymer having ion-conductivity. Since the molecule having magnetic field aeolotropy is oriented by the strong magnetic field, it is possible to improve the strength of the membrane in a certain direction. An example of the molecule having magnetic field aeolotropy is a molecule having benzene rings. Other examples of the molecule having magnetic field aeolotropy include a molecule having imide or amide bond, and a liquid crystal polymer having strong magnetic field aeolotropy.

In each of the first production method and the second production method, the molecular structure having the magnetic field aeolotropy or the molecule having the magnetic field aeolotropy may have benzene rings. The solid polymer electrolyte membrane produced by such a production method is difficult to swell in the direction perpendicular to the direction in which the magnetic field is applied and has high ion-conductivity in the direction in which the magnetic field is applied. An example of such a solid polymer electrolyte membrane is a solid polymer electrolyte membrane in which a polymer having benzene rings in the main chain and a polymer which does not have benzene rings in the main chain are mixed in the electrolyte.

According to another aspect of the invention, there is provided a solid polymer electrolyte membrane produced by one of the above-mentioned production methods.

According to another aspect of the invention, there is provided a fuel cell including a solid polymer electrolyte membrane which is produced by one of the above-mentioned production methods; an anode which is provided on one of both surfaces of the solid polymer electrolyte membrane; and a cathode which is provided on the other surface of the solid polymer electrolyte membrane.

With such a fuel cell, it is possible to improve the electric power generation efficiency by applying a strong magnetic field to the polymer contained in the solid polymer electrolyte membrane such that the ion-conductivity become relatively high in the membrane thickness direction. Also, it is possible to suppress deterioration of the electrolyte membrane by applying a strong magnetic field to the polymer such that swelling in the membrane surface direction is suppressed.

### BRIEF DESCRIPTION OF THE DRAWINGS

The above-mentioned embodiment and other embodiments, objects, features, advantages, technical and industrial significance of this invention will be better understood by reading the following detailed description of the exemplary embodiments of the invention, when considered in connection with the accompanying drawings, in which:

FIG. 1 is a cross sectional view showing a cell which includes an electrolyte membrane according to an embodiment of the invention, and which is a structural unit of a fuel cell;

FIG. 2 is a flowchart showing a first production method for an electrolyte membrane;

FIG. 3 is a flowchart showing a second production method for an electrolyte membrane;

FIG. 4 shows a conceptual view of a fluorinated electrolyte membrane before application of a magnetic field, and a conceptual view of the fluorinated electrolyte membrane after the application of the magnetic field; and

FIG. 5 shows a conceptual view of an aromatic hydrocarbon electrolyte membrane before application of a magnetic field and a conceptual view of the aromatic hydrocarbon electrolyte membrane after the application of the magnetic field.

### DETAILED DESCRIPTION OF THE EXEMPLARY EMBODIMENTS

In the following description, the present invention will be described in more detail in terms of exemplary embodiments.

A structure of a fuel cell will be schematically described. According to the invention, polymers contained in a solid polymer electrolyte membrane (hereinafter, simply referred to as an “electrolyte membrane”) are oriented in a certain direction in strong magnetic fields. First, a structure of a polymer electrolyte fuel cell including this electrolyte membrane will be briefly described.

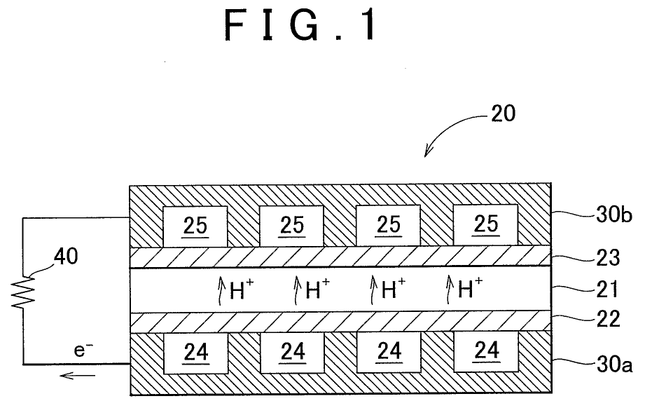

FIG. 1 is a cross sectional view showing a cell 20 which includes an electrolyte membrane 21 according to an embodiment of the invention, and which is a structural unit of a fuel cell. As shown in FIG. 1, the cell 20 includes the electrolyte membrane 21; an anode 22 and a cathode 23 which makes a pair and which sandwich the electrolyte membrane 21 such that a sandwich structure is formed; and separators 30a and 30b which sandwich the sandwich structure. Fuel gas passages 24, through which hydrogen serving as fuel gas flows, are formed between the anode 22 and the separator 30a. Oxidizing gas passages 25, through which air serving as oxidizing gas flows, are formed between the cathode 23 and the separator 30b.

The electrolyte membrane 21 has ion-conductivity, and selectively permits a proton (H⁺) as a cation to permeate therethrough from the anode 22 side to the cathode 23 side. The electrolyte membrane 21 contains a fluorinated polymer containing a sulfonic acid group as an ion-exchange group, or a hydrocarbon polymer. The proton permeates through a hydrophilic cluster region that is formed of a cluster of sulfonic acid groups, thereby moving in the membrane thickness direction of the electrolyte membrane 21. A production method for the electrolyte membrane 21, and features of the electrolyte membrane 21 will be described later in detail. Surfaces of the electrolyte membrane 21 are coated with catalytic paste which contains platinum or an alloy of platinum and another metal as a catalyst.

Each of the anode 22 and the cathode 23, serving as a gas diffusion electrode, is made of a material having sufficient gas diffusivity and conductivity. Examples of such a material include carbon cloth, carbon paper, and carbon felt that are woven out of thread made of carbon fibers.

Each of the separators 30a and 30b is made of a gas-non-permeable conductive material. Examples of such a material include gas-non-permeable and densified carbon that is obtained by compressing carbon, and a metal member. Each of the separators 30a and 30b has a ribbed portion having a predetermined shape in the surface thereof. As described above, the fuel gas passages 24 are formed between the separator 30a and the anode 22, and the oxidizing gas passages 25 are formed between the separator 30b and the cathode 23.

In the cell 20 formed in the above-mentioned manner, when fuel gas containing hydrogen is supplied through the fuel gas passages 24 and air containing oxygen is supplied through the oxidizing gas passages 25, electrochemical reactions proceed on the catalysts provided on the surfaces of the electrolyte membrane 21. The electrochemical reactions are expressed by the following equations.

H₂→2H⁺+2e⁻ Equation (1)

2H⁺+2e⁻+(½)O₂→H₂O Equation (2)

H₂+(½)O₂→H₂O Equation (3)

The equation (1) represents the reaction that occurs on the anode 22 side. The equation (2) represents the reaction that occurs on the cathode 23 side. The equation (3) represents the reaction performed in the entire fuel cell. As expressed by the equation (1), the electron (e⁻) generated by the reaction on the anode 22 side moves to the cathode 23 side through an outside circuit 40, and is used for the reaction expressed by the equation (2). The proton (H⁺) generated by the reaction expressed by the equation (1) moves to the cathode 23 side through the electrolyte membrane 21, and is used for the reaction expressed by the equation (2). According to these equations, water is generated on the cathode 23 side by the chemical reaction performed in the entire fuel cell. A part of the thus generated water is absorbed by the electrolyte membrane 21, and the other part of the water is discharged to the outside of the fuel cell.

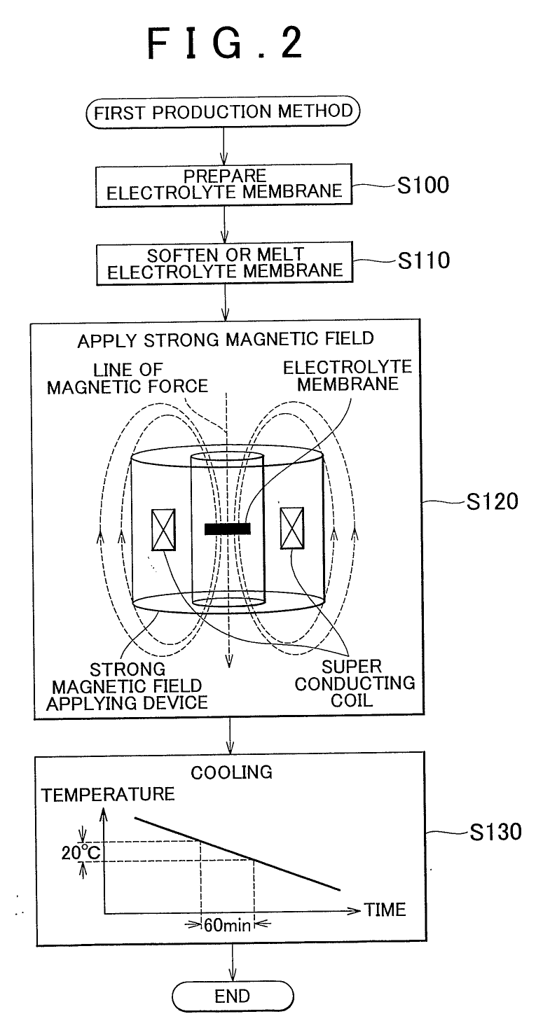

Next, a first production method for the electrolyte membrane 21 shown in FIG. 1 will be described. FIG. 2 is a flowchart showing the first production method for the electrolyte membrane 21. First, an already available electrolyte membrane is prepared in step S100. For example, a fluorinated electrolyte membrane such as a perfluoro sulfonic acid membrane, or a hydrocarbon electrolyte membrane is prepared. As the hydrocarbon electrolyte membrane, for example, a membrane obtained by sulfonating an engineering plastic polymer may be used. Examples of the engineering plastic polymer include polyether ether ketone, polyether sulfone, polyether imide, polyphenylene ether, polypropylene, polyphenylene sulfide, polyacetal resin, polyethylene, polyethylene terephthalate, polyvinyl chloride, polysulfone, polycarbonate, polyamide, polyamide imide, polyimide, polybenzimidazole, polybutylene terephthalate, acrylonitrile-butadiene-styrene, polyacrylonitrile, and polyvinyl alcohol. As a matter of course, an electrolyte membrane that is newly formed by the molten material extrusion method or the solution cast method may be prepared, instead of such an already available electrolyte membrane.

Next, in step S110, the electrolyte membrane prepared in step S100 is heated while performing a nitrogen purge at a temperature lower than the temperature at which the polymer contained in the electrolyte membrane is decomposed (for example, 180° C. to 200° C.), such that the electrolyte membrane is softened or melted. Thus, the flowability of the polymer contained in the electrolyte membrane is improved.

Next, a strong magnetic field is applied to the softened or melted electrolyte membrane in the membrane thickness direction in step S120. As a device for applying a strong magnetic field to the electrolyte membrane, for example, a strong magnetic field applying device, “HF10-150VT” manufactured by Sumitomo Heavy Industries Ltd. may be used. In such a strong magnetic field applying device, an electric current is applied to a super conducting coil formed so as to have a hollow cylindrical shape, whereby strong magnetic fields are generated in the axial direction in the cylinder. Accordingly, if the electrolyte membrane is placed in this cylinder, the polymers contained in the electrolyte can be oriented in a certain direction. The strength of the magnetic field applied to the electrolyte is approximately 10 tesla.

In step S130, the electrolyte membrane is cooled for several hours such that the temperature decreases, for example, by 20° C. during 60 minutes according to a predetermined profile, while being applied with a strong magnetic field. Thus, the electrolyte membrane is solidified or hardened. Performing the above-mentioned steps makes it possible to relatively easily produce the electrolyte membrane in which the polymers are oriented and fixed in the certain direction according to the direction in which the strong magnetic field is applied.

The electrolyte membrane in which the polymers are oriented in a certain direction can be produced by a second production method, instead of by the first production method. The second production method will be described in detail.

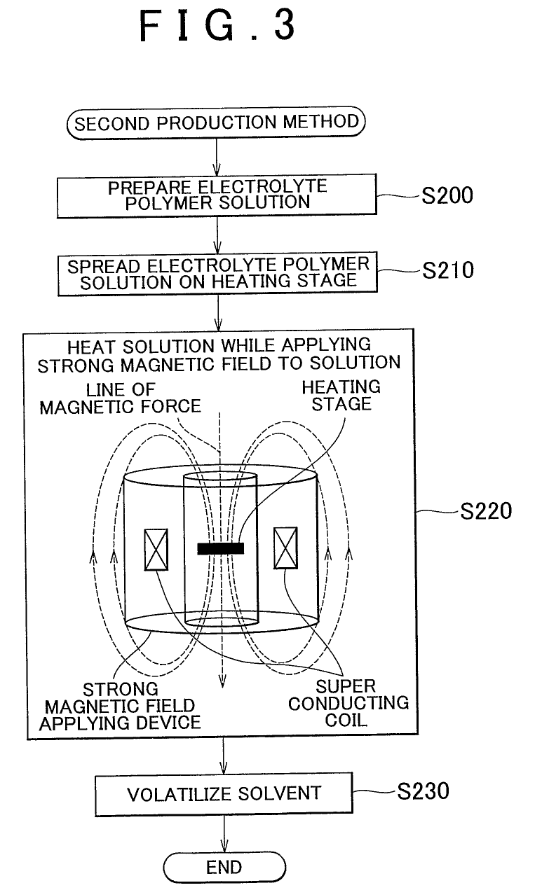

FIG. 3 is a flowchart showing the second production method for an electrolyte membrane. First, an electrolyte polymer solution is prepared in step S200. The electrolyte polymer solution can be obtained by dispersing a fluorinated or hydrocarbon electrolyte polymer having ion-conductivity in a solvent, for example, alcohol.

Next, in step S210, the electrolyte polymer solution is spread so as to have a film shape on a heating stage to which Teflon (registered trademark) has been applied. Then, the solution is heated by using the heating stage while a strong magnetic field of approximately 10 tesla is applied to the solution in the membrane thickness direction in step S220. Thus, the solvent is volatilized in step S230. The same device for applying a strong magnetic field as the one used in the first production method may be used also in the second production method.

Performing the above-mentioned steps also makes it possible to easily produce the electrolyte membrane in which the polymers are oriented in a certain direction according to the direction in which the strong magnetic field is applied. Also, with the second production method, the flowability of the polymer can be improved by the solvent. It is, therefore, possible to further improve the orientation of the polymer.

In each of the first production method and the second production method, an electrolyte in which the ion-exchange group contained in the polymer is substituted by fluorine or salt, or an electrolyte in which an end cap process is performed may be used. Also, an electrolyte to which a plasticizer has been added may be used. If such a process is performed, the melting viscosity of the electrolyte is decreased. Accordingly, such a process is especially effective when the electrolyte that is difficult to soften or melt only by heating is used.

Next, the properties of the electrolyte membrane produced by the first or second production method will be described.

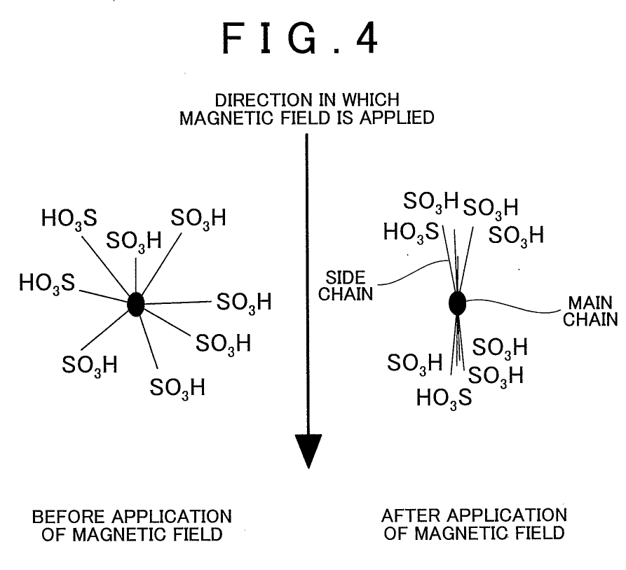

FIG. 4 shows a conceptual view of the fluorinated electrolyte membrane before application of a magnetic field, and a conceptual view of the fluorinated electrolyte membrane after the application of the magnetic field. As shown in the view on the left side in FIG. 4, before application of the magnetic field, the fluorinated polymer has a structure in which a linear main chain is located at the center, and side chains, each of which has a sulfonic acid group (SO₃H) at the end thereof, are isotropically located 360 degrees around the main chain. In FIG. 4, the main chain extends in a direction perpendicular to the paper on which FIG. 4 is shown. However, after the magnetic field is applied by the above-mentioned production method, as shown in the view on the right side in FIG. 4, the main chain is oriented in the direction perpendicular to the direction in which the magnetic field is applied, and the side chains are oriented in the direction parallel to the direction in which the magnetic field is applied. With such a structure of the electrolyte membrane, a large number of sulfonic acid groups as the ion-exchange groups are continuously provided in the membrane thickness direction. Therefore, the hydrophilic cluster region extends in the membrane thickness direction, and the ion-conductivity is improved in the membrane thickness direction. If such an electrolyte membrane is used, the electric power generation efficiency of the fuel cell shown in FIG. 1 can be improved.

As the fluorinated polymer, the perfluoro sulfonic acid polymer may be used. Instead of this, a polymer having benzene rings between the main chain and the side chains may be used. The benzene ring has a relatively strong tendency to be oriented in the direction parallel to the direction in which the magnetic field is applied. It is, therefore, possible to produce an electrolyte membrane with further improved ion-conductivity. Examples of the polymer having benzene rings between the main chain and the sulfonic acid groups include sulfonated poly (4-phenoxy benzoyl-1,4-phenylene) (S—PPBP), 3-6 sulfonated polybenzimidazole, sulfonated polyether sulfone, sulfonated poly (arylether sulfone), and sulfonated fullerenol.

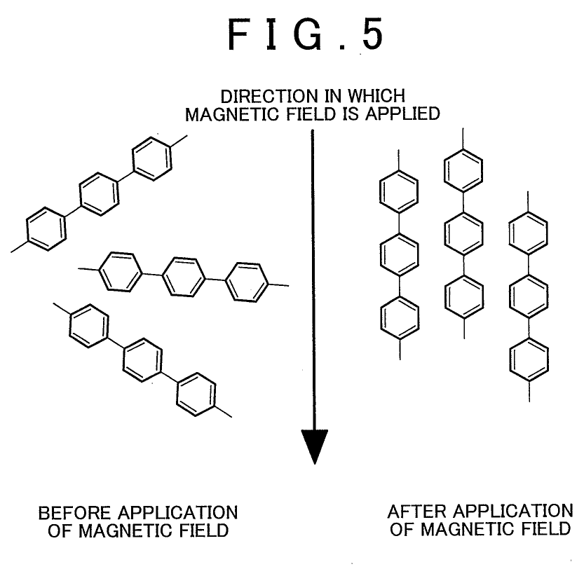

FIG. 5 shows a conceptual view of the aromatic hydrocarbon electrolyte membrane before application of a magnetic field and a conceptual view of the aromatic hydrocarbon electrolyte membrane after the application of the magnetic field. As shown in the view on the left side in FIG. 5, the aromatic hydrocarbon polymers each of which has benzene rings in the linear main chain are oriented in random directions before application of the magnetic field. However, after the strong magnetic field is applied by the above-mentioned production method, the main chains are oriented in the direction parallel to the direction in which the magnetic field is applied. When such an electrolyte membrane is used for the fuel cell, even if the electrolyte membrane swells by absorbing water, the electrolyte membrane tends to swell in the membrane thickness direction rather than in the membrane surface direction. Accordingly, an excessive stress is not applied to portions at which the electrolyte membrane and the other members (for example, the anode 22 and the cathode 23) are joined to each other, and therefore deterioration of the electrolyte membrane can be suppressed.

The aromatic hydrocarbon polymer having benzene rings in the linear main chain is obtained by sulfonating the aromatic engineering plastic. Examples of the aromatic engineering plastic include polyether ether ketone, polyaryl ether ketone, polyether ketone, polyketone, polyether sulfone, polysulfone, polyphenylene sulfide, and polyphenylene ether.

Each of the electrolyte membrane prepared in step S100 in the first production method and the electrolyte polymer prepared in step S200 in the second production method may contain single type of polymer. However, each of the electrolyte membrane prepared in step S100 in the first production method and the electrolyte polymer prepared in step S200 in the second production method may be a compound containing two types of polymers, for example, one of which is the above-mentioned aromatic hydrocarbon polymer and the other of which is the polymer that has ion-conductivity and that does not have benzen rings in the main chain. When a strong magnetic field is applied to such an electrolyte in the membrane thickness direction, the electrolyte is difficult to swell in the membrane surface direction, since the two types of polymers have different orientations. It is, therefore, possible to produce the electrolyte membrane having high ion-conductivity in the membrane thickness direction.

Examples of the polymer which has ion-conductivity and which does not has benzen rings in the main chain are a perfuluoro sulfonic acid polymer and an aliphatic polymer. Examples of a polymer which has an aliphatic main chain and which has ion-conductivity include polyvinyl sulfonic acid, polystyrene sulfonic acid, quaternary polyvinyl pyridine, a sulfonated styrene-butadiene copolymer, and a block copolymer of sulfinated styrene/etyrene-butadiene. Generally, an AB type polymer which has a sulfonated polymer as “A” and etyrene or butadiene as “B” may be used.

Instead of preparing the electrolyte, in which two types of polymers are used, in the above-mentioned manner, a polymer having a structure in which benzene rings are included in a linear main chain and each side chain is formed by connecting carbon atoms linearly, or a polymer having a structure in which a main chain is formed by connecting carbon atoms linearly and benzene rings are included in each side chain may be used. An example of such an electrode is butyl sulfonated polybenzimidazole. When a strong magnetic field is applied to such an electrolyte, the main chain and the side chains are oriented in the different directions. It is, therefore, possible to produce the electrolyte membrane where the direction in which the membrane swells and the direction in which the ion is conducting are appropriately controlled.

According to the embodiment described so far, applying a strong magnetic field during a process of solidification of the electrolyte membrane makes it possible to produce an excellent electrolyte membrane having physical properties imparted with aeolotropy, for example, the electrolyte membrane in which the swelling of the membrane in the membrane surface direction can be suppressed, and the electrolyte membrane having high ion-conductivity in the membrane thickness direction.

While the invention has been described in detailed with reference to the preferred embodiment, the invention is not limited to the above-mentioned embodiment, and the invention may be realized in various other embodiments within the scope of the invention.

For example, in the first production method, the electrolyte membrane prepared in step S100 is softened or melted in order to improve the flowability of the polymer contained in the electrolyte membrane. However, the method of improving the flowability of the polymer is not limited to this. For example, the electrolyte membrane may be dissolved in a solvent.

1-10. (canceled)

11. A production method for a solid polymer electrolyte membrane having physical properties imparted with aeolotropy, comprising:
softening, melting or dissolving a first state solid polymer electrolyte membrane containing a polymer having an ion-exchange group, thereby forming a second state solid polymer electrolyte membrane; and
applying a magnetic field to the second state solid polymer electrolyte membrane in a predetermined direction, while hardening or solidifying the second state solid polymer electrolyte membrane, wherein said magnetic field has a strength such that said polymer contained in the solid polymer electrolyte membrane is oriented in a certain direction.

12. The production method for a solid polymer electrolyte membrane according to claim 11, wherein
the solid polymer electrolyte membrane is hardened or solidified by being cooled.

13. The production method for a solid polymer electrolyte membrane according to claim 11, wherein
in the first state solid polymer electrolyte membrane, at least one of substitution of fluorine or salt for the ion-exchange group, an end cap process for the ion-exchange group, and addition of a plasticizer is performed.

14. A production method for a solid polymer electrolyte membrane having physical properties imparted with aeolotropy, comprising:
dispersing a polymer having an ion-exchange group in a solvent, thereby preparing an electrolyte polymer;
forming the electrolyte polymer into a film shape; and
applying a magnetic field to the electrolyte polymer formed into the film shape in a predetermined direction, while volatilizing the solvent present in. the electrolyte polymer, wherein said magnetic field has a strength such that said electrolyte polymer is oriented in a certain direction.

15. The production method for a solid polymer electrolyte membrane according to claim 14, wherein
the solvent present in the electrolyte polymer formed into the film shape is volatilized by being heated.

16. The production method for a solid polymer electrolyte membrane according to claim 11, wherein,
in the polymer having the ion-exchange group, each molecule has a molecular structure having magnetic field aeolotropy and a molecular structure having ion-conductivity.

17. The production method for a solid polymer electrolyte membrane according to claim 14, wherein,
in the polymer having the ion-exchange group, each molecule has a molecular structure having magnetic field aeolotropy and a molecular structure having ion-conductivity.

18. The production method for a solid polymer electrolyte membrane according to claim 11, wherein
the polymer having the ion-exchange group is a compound of a polymer having magnetic field aeolotropy and a polymer having ion-conductivity.

19. The production method for a solid polymer electrolyte membrane according to claim 14, wherein
the polymer having the ion-exchange group is a compound of a polymer having magnetic field aeolotropy and a polymer having ion-conductivity.

20. The production method for a solid polymer electrolyte membrane according to claim 16, wherein
the molecular structure having the magnetic field aeolotropy or the molecule having the magnetic field aeolotropy has benzene rings.

21. The production method for a solid polymer electrolyte membrane according to claim 17, wherein
the molecular structure having the magnetic field aeolotropy or the molecule having the magnetic field aeolotropy has benzene rings.

22. The production method for a solid polymer electrolyte membrane according to claim 18, wherein
the molecular structure having the magnetic field aeolotropy or the molecule having the magnetic field aeolotropy has benzene rings.

23. The production method for a solid polymer electrolyte membrane according to claim 19, wherein
the molecular structure having the magnetic field aeolotropy or the molecule having the magnetic field aeolotropy has benzene rings.

24. A solid polymer electrolyte membrane which is produced by the production method according to claim 11.

25. A solid polymer electrolyte membrane which is produced by the production method according to claim 14.

26. A fuel cell, comprising:
a solid polymer electrolyte membrane which is produced by the production method according to claim 11;
an anode which is provided on one of both surfaces of the solid polymer electrolyte membrane; and
a cathode which is provided on the other surface of the solid polymer electrolyte membrane.

27. A fuel cell, comprising:
a solid polymer electrolyte membrane which is produced by the production method according to claim 14;
an anode which is provided on one of both surfaces of the solid polymer electrolyte membrane; and
a cathode which is provided on the other surface of the solid polymer electrolyte membrane.
